(19) United States
(12) Patent Application Publication
(10) Pub. No.: US 2019/0090105 A1
(43) Pub. Date: Mar. 21, 2019

(54) DENSE DATA ACQUISITION, STORAGE AND RETRIEVAL

(71) Applicant: AIRVIZ INC., Pittsburgh, PA (US)

(72) Inventors: Illah Nourbakhsh, Pittsburgh, PA (US); Christopher Bartley, Pittsburgh, PA (US); Joshua Schapiro, Pittsburgh, PA (US)

(21) Appl. No.: 16/085,854

(22) PCT Filed: Feb. 7, 2017
(86) PCT No.: PCT/US17/16833

§ 371 Date: Sep. 17, 2018

Related U.S. Application Data
(60) Provisional application No. 62/341,938, filed on May 26, 2016.

(51) Int. Cl. H04W 4/38; H04L 29/08; G06F 17/30; H04W 4/80; H04L 29/06; G06F 9/54

(52) U.S. Cl. CPC H04W 4/38; H04L 67/1097; G06F 17/30997; G06F 9/544; H04W 4/80; H04L 69/161; G06F 17/30861

(57) ABSTRACT

Systems and method implement end-to-end capture of data fluents, the treating of said data locally, transmission of the data to a scalable server infrastructure, and retrieval and visualization of the data in a computationally efficient manner. Data is retrieved using a local electronic device that immediately time stamps data values and stores the values on a local buffer in order to compensate for any wireless signal vagaries. Local wireless configuration of the device consists of wireless-based configuration interactive menus, enabling high ease- of-use during setup and administration. Data is then communicated during times of Internet connectivity to an online data storage repository. The online data repository, in turn, resamples the incoming data across temporal resolutions to aggregate efficiently for data visualization at any temporal resolution downstream, then provides data retrieval services for Internet-based visualization algorithms that request and serve data at appropriate resolutions for user need.

### PRIORITY CLAIM

The present application claims priority to U.S. provisional patent application Ser. No. 62/341,938, filed May 26, 2016, with the same title and inventors as above, and which is incorporated herein by reference in its entirety.

### BACKGROUND

Greatly increasing numbers of environmental and process sensors are being used in production systems and environmental monitoring systems. Yet the data storage and retrieval challenge faced for such systems poses significant technical issues, including the following: local storage is critical if data communication is unreliable or transient; data at dense temporal rates requires local time stamping for accuracy; data transport needs to be able to use diverse wireless protocols which, in turn, must be configurable by the user with ease; data storage demands data architectures that enable massive temporal scaling and have ontologically sound primitives for data insertion, tagging and retrieval operations; and finally visualization systems must afford human-readable access to data across diverse mobile platforms.

### SUMMARY

In one general aspect, the present invention is directed to the end-to-end capture of data fluents, the treating of said data locally, transmission of the data to a scalable server infrastructure, and retrieval and visualization of the data in a computationally efficient manner. Data is acquired using a local electronic device that immediately timestamps data values and stores the values on a local buffer in order to compensate for any wireless signal vagaries. Data is then communicated during times of Internet connectivity to an online data storage repository. The online data repository, in turn, resamples the incoming data across temporal resolutions to aggregate efficiently for data visualization at any temporal resolution downstream, then provides data retrieval services for Internet-based visualization algorithms that request and serve data at appropriate resolutions for user need.

### FIGURES

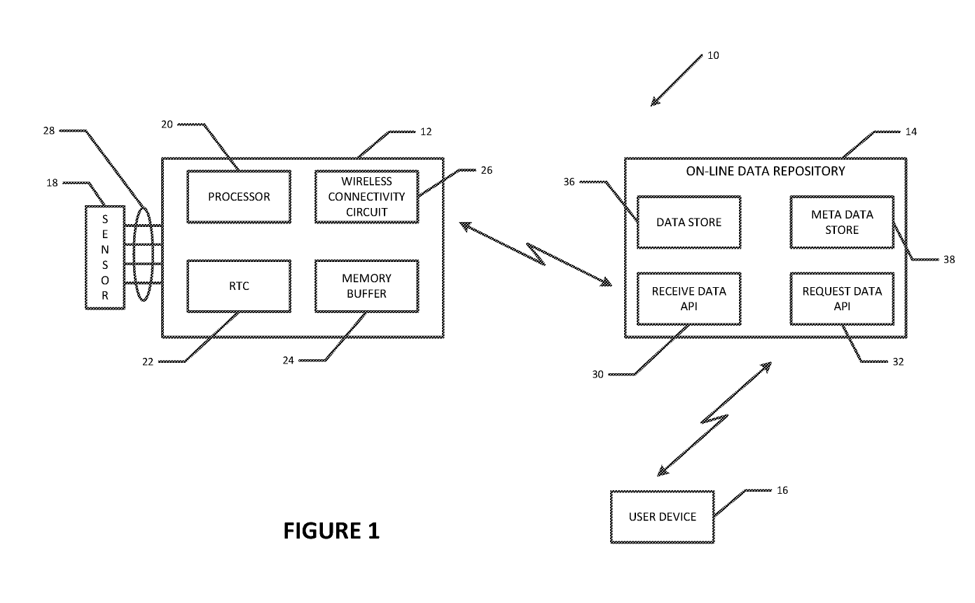

Various embodiments of the present invention are described herein by way of example in connection with the following figures, wherein FIG. 1 is a block diagram of a system according to various embodiments of the present invention.

### DESCRIPTION

In one general aspect, the present invention is directed to an online data acquisition, storage, and retrieval system. FIG. 1 is a simplified, exemplary block diagram of the system 10 according to various embodiments of the present invention. The illustrated system 10 includes a data acquisition unit 12, an online data repository 14, and a user device 16. In brief, the data acquisition unit 12 locally timestamps and stores sensor data from one or more sensors 18 (only one of which is shown in FIG. 1 for simplicity). The data acquisition unit 12 may be in wireless communication with the online data repository 14, such as via an ad hoc wireless communication link or via an infrastructure wireless communication link (e.g., wireless access point to router to Internet, or Bluetooth low energy (BLE) to cellular router to Internet, etc.). During times of connectivity there between, timestamped sensor data are uploaded from the data acquisition unit 12 to the online data repository 14, where the data are stored in a multiresolution fashion, described further below. Metadata for the sensor data is also uploaded and stored at the online data repository 14. The user device 16 can access the data from the online data repository 14.

The data acquisition unit 12 may include a processor (e.g., a microprocessor) 20, a real-time clock (RTC) 22, a memory buffer 24, and wireless connectivity circuit 26. These components could be implemented as separate integrated circuits, or some or all of them could be combined (such as in a system-on-chip, SOC). Also, all these components could be connected to a single printed circuit board (PCB), although they do not need to be, depending on the circumstances.

Sensor data from the sensor 18 are input to the data acquisition unit 12 via one or more digital or analog input lines 28. The sensor 18 could be any type of sensor that detects events or changes in its environment over time, and provides a corresponding output on the input lines 28. For example, the sensor 18 could be an acoustic or vibration sensor; a chemical sensor; an electromagnetic property sensor (voltage, current, magnetic field, radio direction, etc.); a flow or fluid velocity sensor; a particle sensor; a navigational instrument; a position, angle, displacement, speed or acceleration sensor; a light or optical sensor; a pressure sensor; a force, density or level sensor; a thermal or temperature sensor; a proximity or presence sensor, etc. The RTC 22 is a clock circuit that keeps track of the current time. It may use a crystal oscillator, for example, and may be implemented with a RTC integrated circuit (IC). The memory buffer 24 may be implemented with a physical data storage medium, such as RAM or some other type of suitable data storage. Under control of the processor 20, sensor data values received from the sensor 18 are timestamped with the clock output from the RTC 22, and the time-stamped data are stored in the memory buffer 24.

The wireless connectivity circuit 26 transmits the time-stamped sensor data stored in the memory buffer 24 to the online data repository 14 during the periods of connectivity there between. When there is no wireless connectivity, the time-stamped data can be stored in the memory buffer 24 (up to the storage capacity of the memory buffer 24) until such time as wireless connectivity is reestablished for transmission of the data to the online data repository 14. The wireless connective circuit 26 can use any suitable wireless communication protocol for communicating with the online data repository 14. The communications could be direct or indirect via multi-hop, ad hoc or infrastructure wireless networks. For example, in one embodiment, the data acquisition unit 12 may include a WiFi (IEEE 802.11x) or ZigBee (IEEE 802.15.4) circuit or chip (e.g., an integrated circuit or IC) that allows the data acquisition unit 12 to communicate with the online data repository 14 via a WiFi or ZigBee network as the case may be. In another embodiment, the data acquisition unit 12 may include a BLE circuit or chip that allows the data acquisition unit 12 to transmit the sensor data wirelessly to a device (not shown) that is Bluetooth linked to the data acquisition unit 12. The device could be a mobile device, such as a laptop or smartphone, or a stationary device, such as a desktop PC or any other suitable non-mobile computer hardware device with BLE support. The device can transmit the data to the online data repository 14, e.g., via modem, a WiFi or LTE cellular network, or any other network type that the device uses to connect to the Internet. As such, in such an embodiment, the device acts as a router for the data acquisition unit 12 whenever the device is available to do so (e.g., there is a data link between the data acquisition unit 12 and the device). FIG. 1 does not show for the sake of clarity well-understood equipment that might be used in an ad hoc or infrastructure wireless network, such as other nodes, routers, or access points, for example.

The data acquisition device's processor 20 may also execute a TCP/IP stack so that it can act as an embedded web server for configuration purposes. A user (such as of the user device 16 or another computer device that is in communication with the data acquisition unit 12) can open a web page hosted by the embedded web server based on the IP address for the data acquisition unit 12. Via the web page, the user could configure the data acquisition unit 12, such as the sampling frequency for acquiring data from the sensor 18, or other features of the configuration such as WEP encryption configuration parameters, SSID preferences, batch upload specifications, etc. The web page may provide configuration interactive menus, enabling high ease-of-use during setup and administration of the data acquisition unit 12. The configuring device may be in wired or wireless communication with the data acquisition unit 12.

The online data repository 14 may be implemented as one or a number of network HTTP servers. Each such server may include one or more processors, primary storage (e.g., memory units such as RAM and ROM), and secondary storage (e.g., HDDs, etc.). In particular, the online data repository 14 may communicate with the data acquisition unit 12, wirelessly as described above, via a receive data API 30 that defines the format for uploading the time-stamped sensor data. In various embodiments, the API 30 can be a representational state transfer (REST) API, for example. Similarly, the user device 16 may request data from the online data repository 14 using a request data API 32, which defines the data formats, etc., by which the user device 16 can request and receive in return data from the online data repository 14.

As shown in FIG. 1, various servers implementing the online data repository 14 may comprise a data store 36 and a meta data store 38. The data stores 36, 38 can be implemented with databases that store data in primary and/or secondary computer data storage, such as RAM, ROM, hard disk drives, optical disk drives, solid state drives, flash memory, RAID disk arrays, etc. In various embodiments, the data store 36 stores numerous series of the time-stamped sensor data in multi-temporal resolutions, e.g., resolutions that are lower order than the sampling rate at which the sensor collects the data. That is, the online data repository 14 may store all the collected data samples transmitted from the data acquisition unit 12, as well as averages of the data over many or several different, lower-order temporal resolutions. In various embodiments, the data store 36 stores the averages (e.g., arithmetic mean) by powers of two. For example, the data store 36 can store the original data (2⁰ resolution, the highest resolution), as well as averages of 2, 4, 8, 16, 32, 64, 128, 256, 512, 1024, etc. consecutive data samples (corresponding to 2¹ to 2¹⁰ lower order resolutions, and so on). For example, if the sensor 18 collects sample values every 0.5 seconds, the data store 36 could store over the following temporal ranges:

| | | CORRESPONDING |
|---|---|---|
| RESOLUTION | # OF | TIME PERIOD |
| ORDER* | SAMPLES | (SECONDS) |
| 0 | 1 | 0.5 |
| 1 | 2 | 1.0 |
| 2 | 4 | 2.0 |
| 3 | 8 | 4.0 |
| 4 | 16 | 8.0 |
| 5 | 32 | 16.0 |
| 6 | 64 | 32.0 |
| 7 | 128 | 64.0 |
| 8 | 256 | 128.0 |
| 9 | 512 | 256.0 |
| 10 | 1024 | 512.0 |

. . .

| | | |
|---|---|---|
| 25 | 33,554,432 | 16,777,216.0 |

*Greater resolution order values represent lower order temporal resolutions

The resolutions could continue up to, for example, a resolution time period covering close to or more than one calendar year. Where multiple data acquisition units 12 upload data to the online data repository 14 and/or one data acquisition unit 12 transmits data for multiple sensors 18, the online data repository 14 can store the computed multi-, lower-order temporal resolution data for each such sensor 18.

The meta data store 38 stores high level data about the sensor data, such as the location of the sensor (GPS coordinates, data value type, data units, zip code, township, school district, congressional district, etc.), the owner or administrator of the sensor, the maker of the sensor, indoor vs. outdoor, data private/public flag, sensor hardware type and revision number, etc. The meta data store 38 can store the meta data for each sensor 18 whose time-stamped sensor data are uploaded to the online data repository 14.

In the above-description, the data store 36 stored arithmetic means with resolutions by powers of two. In other embodiments, other mathematical functions besides the arithmetic means and/or other time resolutions could be used (in addition to or in lieu of the arithmetic means by powers of two). For example, the median, mode, a nonarithmetic mean (e.g., a geometric mean), a randomly selected sample value in the temporal range, etc., could be stored by the data store 36. Also, the resolution may be by powers other than 2, such as 3, 4, 5, etc., for example. And the temporal resolutions need not increase by powers; they could just be selected/desired resolutions (50 samples, 100 samples, 500 samples, 1000 samples, and so on).

The user device 16 can be implemented with a processor-based computer device that is capable of requesting data from the online data repository 14 via the request data API 32 and rendering that data for a user of the user device 16. For example, the user device 16 can include web browser software for requesting the data from the online data repository 14, an interface through which a user can specify a data query (e.g., the type (or parameters) of the sensor data requested), and a display for visually rendering the sensor data that satisfies the user's data query on the user device 16. The user device 16 could be implemented by, for example, a laptop computer, a PC, a smartphone, a tablet computer, a wearable computer, etc. with a suitable display for displaying the returned data. The data inquiry could be a specific sensor data for a specific sensor 18, over a specified time period, at a specified temporal resolution (e.g., daily average over a year). Or the data inquiry could cover a number of sensors 18, such as sensors in a particular geographic area (e.g., zip code) over a specified time period at the specified resolution; or sensors owned/administered by a particular party (e.g., the government) in a specified geographic area over a specified time period at the specified resolution; etc. The online data repository 14 could use default temporal resolutions for variously selected calendar time periods (e.g., daily average of monthly time intervals, weekly averages for annual time intervals), or the user could override the default settings through the interactive means to specify a desired temporal resolution.

The online data repository 14 preferably includes a database management system (DBMS, not shown) or other software application that allows querying of the data stored in the data stores 36, 38 based on the search criteria from the user. To fetch the data that satisfy a particular data query from the user, the DBMS of the online data repository 14 can first query the meta data store 38 for the sensors that satisfy the query (e.g., sensors located in a specified geographic area and/or with a specific data type), and then retrieve the sensor data in the data store 36 for those sensors, at the desired resolution, for transmission to the user device 16. For example, the user could interrogate the online data repository 14 for sensor values at variable levels of resolution with temporal bounds, etc. For example, the user could request, from the user device 16, via the request data API 32, sensor values for sensors that satisfy certain user-input criteria, such as sensors located in a certain geographic location (e.g., zip code). Further, the user could request average daily values, or some other level of resolution, for the sensors that satisfy the criteria, over some time period, ranging from a starting point to an end point (e.g., Jan. 1 of a year to Dec. 31 of that year). Assuming the online data repository 14 generated sample values at that resolution, the online data repository 14 could then transmit the data via the request data API 32.

The user device 16 could have a wired or wireless connection to the online data repository 14. The interactive means of the user device 16 through which the user could input the data query parameters can include a touch-screen interface, a keyboard, a mouse or trackball, voice recognition, etc. The data may be displayed in tabular form, or in charts or graphs, for example. In that connection, the user could select the desired display format (table, graph, etc.) via the interactive means. As such, for example, the user could scroll using their mouse or trackball or touch screen interface to zoom in on a particular time range or out to a broader (longer) time scale.

In various embodiments, a data acquisition unit 12 could be associated with multiple sensors 18, in which case the data acquisition unit 12 may comprise one or more memory buffers 24 for storing the time-stamped data samples for the various sensors 18 and may transmit the time-stamped data samples for the various sensors 18 to the online data repository 14 as described above.

Also, in the above-described embodiments, the data acquisition unit 12 was in wireless communication with the online data repository 14. In other embodiments, the data acquisition unit 12 has a wired connection (e.g., Ethernet) to an Internet gateway (not shown) that is in communication with the online data repository 14 via the Internet.

Also, in other embodiments, the online data repository 14 need not be “online” or in the cloud. In such an embodiment, one or more data acquisition units 12 communicate with the data repository 14, via wired or wireless (e.g., WiFi, BLE, etc.) links, without the Internet. In such embodiments, the local server(s) acting as the data repository could also run an instance of ESDR (efficient and secure data repair).

In one general aspect, therefore, the present invention is directed to a system comprising a sensor 18, a data acquisition 12 and a data repository (such as an online data repository 14). The data acquisition unit 12 is in communication with the sensor 18 and comprises: a RTC circuit 22; a memory buffer 24 for storing time-stamped sensor data samples from the sensor 18 that are time stamped with time values from the RTC circuit 22; and optionally a wireless connectivity circuit 26 for wirelessly transmitting the time-stamped sensor data samples. The data repository 14 comprises a data store 36 and at least one processor (not shown). The data repository 14 receives (e.g., wirelessly) and stores in the data store 36, the time-stamped sensor data samples stored in the memory buffer 24 of the data acquisition unit 12 and transmitted by the data acquisition unit 12 to the data repository 14, e.g., during periods of wireless connectivity for the data acquisition unit 12. The at least one processor of the data repository 14 computes two or more series of lower-order temporal resolution samples of the received time-stamped sensor data samples, where each of the two or more series of lower-order temporal resolution samples are at separate lower-order temporal resolutions that are lower than a sample rate of the received time-stamped sensor data samples. And the data store 36 stores the two or more series of lower-order temporal resolution samples.

In various implementations, the at least one processor of the data repository 14 computes the two or more series of lower-order temporal resolution samples by computing averages of Nj consecutive time-stamped sensor data for two or more values of Nj such as Nj=P̂j, where P>1 and j is at least two different numbers that are each greater than or equal to one, such as P=2 and j=1, 2, 3, . . . . Also, the data repository 14 may further comprise a metadata store 38 that stores metadata about the sensor 18, such as location data for the sensor, an administrator for the sensor, a manufacturer of the sensor, a privacy data indicator for the sensor data, or a sensor hardware type.

Additionally, the data acquisition unit 12 may comprise at least one circuit board, in which case the RTC circuit 22, the wireless connectivity circuit 26, and the memory buffer 24 are mounted to the least one circuit board. The wireless connectivity circuit may comprise a WiFi circuit or a BLE circuit, for example. Also, the data repository 14 may provide an API for interrogating sensor data at variable levels of resolution.

The sensor 18 may comprise a particle sensor, for example, and the data acquisition unit may comprise a processor 20 that executes a TCP/IP stack to act as an embedded web server.

Also, the data repository could be in communication with multiple data acquisition units 12, each collecting and transmitting time-stamped sensor data samples for one or more associated sensors 18. In that case, the data repository 14 could compute the lower-order resolution samples for each sensor 18 and store them in the data store 36. The metadata store 38 could also store metadata for each sensor 18. That way, as described above, a user at a remote computer device 16 could interrogate the data repository 14 for sensor data for particular sensors for a particular temporal resolution over a particular time range. For example, the one or more processors of the data repository 14 may be programmed to: receive a sensor query and resolution request from the remote computer device 16; query the metadata store 38 to determine one or more sensors 18 that satisfy the sensor query; and retrieve from the data store 36 and transmit to the remote computer device 16, for the one ore more sensors 18 that satisfy the sensor query, data samples at the received resolution request.

In another general aspect, the present invention is directed to a data acquisition method that comprises the step of receiving, by the data repository 14, from each of a plurality of data acquisition units 12 that are each associated with a sensor 18, time-stamped sensor data samples of the associated sensor 18, where the sensor data samples for each sensor 18 are time stamped with a time value of a RTC circuit 22 of the associated data acquisition unit 12, and where the data acquisition units 12 transmit the time-stamped sensor data samples, e.g., wirelessly during periods of wireless connectivity therefor. The method also comprises the step of computing, by the data repository 14, two or more series of lower-order temporal resolution samples for each sensor, wherein, for each sensor, the two or more series of lower-order temporal resolution samples are at separate lower-order temporal resolutions that are lower than a sample rate of the received time-stamped sensor data samples for the sensor. The method further comprises the steps of storing, by the data repository 14, the two or more series of lower-order temporal resolution samples in a data store 36 of the data repository and storing, by the data repository 14 in a metadata store 38, metadata about the associated sensors 18 of the plurality of data acquisition units 12.

The method may also comprise the steps of (i) receiving, by the data repository, a sensor query and resolution request from a remote computer device; (ii) determining, by the data repository, based on the metadata stored in the metadata store, one or more sensors that satisfy the sensor query; (iii) retrieving, by the data repository, from the data store, for the one or more sensors that satisfy the sensor query, data samples at the received resolution request; and (iv) transmitting, by the data repository, the retrieved data samples at the received resolution request to the remote computer device.

The examples presented herein are intended to illustrate potential and specific implementations of the present invention. It can be appreciated that the examples are intended primarily for purposes of illustration of the invention for those skilled in the art. No particular aspect or aspects of the examples are necessarily intended to limit the scope of the present invention. Further, it is to be understood that the figures and descriptions of the present invention have been simplified to illustrate elements that are relevant for a clear understanding of the present invention, while eliminating, for purposes of clarity, other elements. For example, the processor(s) and memory units of the online data repository 14 for storing software executed by the processor(s) are not shown since it is understood that the online data repository 14 would have one or more processors and memory units to implement the DBMS. While various embodiments have been described herein, it should be apparent that various modifications, alterations, and adaptations to those embodiments may occur to persons skilled in the art with attainment of at least some of the advantages. The disclosed embodiments are therefore intended to include all such modifications, alterations, and adaptations without departing from the scope of the embodiments as set forth herein.

1. A system comprising:
a sensor;
a data acquisition unit that is in communication with the sensor, wherein the data acquisition unit comprises:
a real-time clock (RTC) circuit;
a memory buffer for storing time-stamped sensor data samples from the sensor, wherein the time-stamped sensor data samples are time stamped with time values from the (RTC) circuit; and
a data repository comprising a data store and at least one processor, wherein:
the data repository receives, and stores in the data store, the time-stamped sensor data samples stored in the memory buffer of the data acquisition unit and transmitted by the data acquisition unit to the data repository;
the at least one processor computes two or more series of lower-order temporal resolution samples of the received time-stamped sensor data samples, wherein each of the two or more series of lower-order temporal resolution samples are at separate lower-order temporal resolutions that are lower than a sample rate of the received time-stamped sensor data samples; and
the data store stores the two or more series of lower-order temporal resolution samples.

2. The system of claim 1, wherein the data acquisition unit further comprises a wireless connectivity circuit for wirelessly transmitting the time-stamped sensor data samples to the data repository during a period of wireless connectivity for the data acquisition unit.

3. The system of claim 2, wherein the data repository comprises an online data repository.

4. The system of claim 1, wherein the at least one processor of the data repository computes the two or more series of lower-order temporal resolution samples by computing averages of Nⱼ consecutive time-stamped sensor data for two or more values of Nⱼ.

5. The system of claim 4, where Nⱼ=P̂j, where P>1 and j is at least two different numbers that are each greater than or equal to one.

6. The system of claim 3, wherein the online data repository further comprises a metadata store that stores metadata about the sensor.

7. The system of claim 6, wherein the metadata about the sensor comprises at least one of: location data for the sensor; an administrator for the sensor; a manufacturer of the sensor;
a privacy data indicator for the sensor data; or a sensor hardware type.

8. The system of claim 3, wherein:
the data acquisition unit comprises at least one circuit board; and
the RTC circuit, the wireless connectivity circuit, and the memory buffer are mounted to the least one circuit board.

9. The system of claim 8, wherein the wireless connectivity circuit comprises a WiFi circuit.

10. The system of claim 8, wherein the wireless connectivity circuit comprises a Bluetooth low energy circuit.

11. The system of claim 3, wherein the online data repository provides an API for interrogating sensor data at variable levels of resolution.

12. The system of claim 1, wherein the sensor comprises a particle sensor.

13. The system of claim 3, wherein the data acquisition unit comprises a processor that executes a TCP/IP stack to act as an embedded web server.

14. A system comprising:
a plurality of sensors;
a plurality of data acquisition units, each data acquisition unit being associated with one of the plurality of sensors, wherein each data acquisition unit comprises:
a real-time clock (RTC) circuit;
a memory buffer for storing time-stamped sensor data samples from the associated sensor that is time-stamped with time values from the (RTC) circuit; and
a wireless connectivity circuit for wirelessly transmitting the time-stamped sensor data samples; and
an online data repository comprising a data store and at least one processor, wherein:
the online data repository receives wirelessly, and stores in the data store, the time-stamped sensor data from each of the data acquisition units during periods of wireless connectivity for the data acquisition units;
the at least one processor computes two or more series of lower-order temporal resolution samples for sensor, wherein, for each sensor, the two or more series of lower-order temporal resolution samples are at separate lower-order temporal resolutions that are lower than a sample rate of the received time-stamped sensor data samples for each sensor; and
the data store stores the two or more series of lower-order temporal resolution samples for each sensor.

15. The system of claim 14, wherein the online data repository further comprises a metadata store that stores metadata about each of the plurality of sensors.

16. The system of claim 15, wherein the at least one processor of the online data repository is programmed to:
receive a sensor query and resolution request from a remote computer device;
query the metadata store to determine one or more sensors that satisfy the sensor query;
retrieve from the data store and transmit to the remote computer device, for the one or more sensors that satisfy the sensor query, data samples at the received resolution request.

17. A data acquisition method comprising:
receiving, by a data repository, from each of a plurality of data acquisition units that are each associated with a sensor, time-stamped sensor data samples of the associated sensor, wherein the sensor data samples for each sensor are time stamped with a time value of a real-time clock (RTC) circuit of the associated data acquisition unit;
computing, by the data repository, two or more series of lower-order temporal resolution samples for each sensor, wherein, for each sensor, the two or more series of lower-order temporal resolution samples are at separate lower-order temporal resolutions that are lower than a sample rate of the received time-stamped sensor data samples for the sensor;
storing, by the data repository, the two or more series of lower-order temporal resolution samples in a data store of the data repository; and
storing, by the data repository in a metadata store, metadata about the associated sensors of the plurality of data acquisition units.

18. The method of claim 17, further comprising:
receiving, by the data repository, a sensor query and resolution request from a remote computer device;
determining, by the data repository, based on the metadata stored in the metadata store, one or more sensors that satisfy the sensor query;
retrieving, by the data repository, from the data store, for the one or more sensors that satisfy the sensor query, data samples at the received resolution request; and
transmitting, by the data repository, the retrieved data samples at the received resolution request to the remote computer device.

19. The method of claim 18, wherein:
the data acquisition unit comprises a wireless connectivity circuit for wirelessly transmitting the time-stamped sensor data samples to the data repository during a period of wireless connectivity for the data acquisition unit; and
the data repository comprises an online data repository.

20. The method of claim 19, wherein computing the two or more series of lower-order temporal resolution samples for each sensor comprises computing averages of Nⱼ consecutive time-stamped sensor data for two or more values of Nⱼ, where Nⱼ=P̂j, where P>1 and j is at least two different numbers that are each greater than or equal to one.
